(19) United States
(12) Patent Application Publication
(10) Pub. No.: US 2004/0064724 A1
(43) Pub. Date: Apr. 1, 2004

(54) Knowledge-based control of security objects

(75) Inventors: Benjamin Andrew Himmel, Yorktown Heights, NY (US); Maria Azua Himmel, Yorktown Heights, NY (US); Herman Rodriguez, Austin, TX (US); Newton James Smith JR., Austin, TX (US); Clifford Jay Spinac, Austin, TX (US)

Correspondence Address: BIGGERS & OHANIAN, PLLC, 5 SCARLET RIDGE, AUSTIN, TX, 78737, US

(73) Assignee: INTERNATIONAL BUSINESS MACHINES CORPORATION, ARMONK, NY

(21) Appl. No.: 10/242,548

(22) Filed: Sep. 12, 2002

(51) Int. Cl. G06F 12/14

(52) U.S. Cl. 713/201; 713/185

(57) ABSTRACT

Controlling access to a resource, including creating a security object in dependence upon user-selected security control data types, including asserting security control data as security facts into a security knowledge database and asserting security rules into the security knowledge database, the security object including security control data and at least one security method, receiving a request for access to the resource, and receiving security request data. Embodiments include asserting the security request data as security facts into the security knowledge database, and determining access to the resource in dependence upon the security facts and security rules in the security knowledge database.

### BACKGROUND OF THE INVENTION

1. Field of the Invention

The present invention relates to data processing methods, apparatus, systems, and computer program products therefor, and more particularly to methods, apparatus, systems, and computer program products in support of securing valid authentication and authorization for access to computer resources and other items.

2. Description Of Related Art

It is common to use passwords to control access to resources, including everything from documents, to bank accounts, burglar alarms, automobiles, home security systems, personal video recorders, and so on. Passwords often consist of text strings that a user must provide to a security system in order to obtain access to a secured resource. A password provided by a user typically is checked against a stored password to determine a match. If the entered password and the stored password match, access is granted to the resource.

Mechanisms for managing passwords typically are programmed into the software applications with which the passwords are associated. That is, a program external to the password is used to authenticate the password, check to see if the password is about to expire, and determine the access granted. Systems securing resources therefore typically have password management operations coded into them to process and authenticate a specific type of password content. Users have no control over how passwords are defined or used in typical systems securing resources. Moreover, changing the way in which a password is used typically requires changing program code in a system securing resources.

In addition, such systems generally are capable of accepting and administering security with respect only one type of password, typically a character string of some predetermined maximum length. If passwords are viewed as one type of security control data, then such systems can be said to function with only one kind of security control data. There is no way in such systems for anyone, especially not a user, to change from a password to some other kind of security control data without substantial redesign and recoding. There is no way in such a system for a user or anyone else to determine to use more than one kind of security control data without substantial redesign and recoding. It would be beneficial to have improved ways of choosing and using security control data to secure resources through computer systems.

### SUMMARY OF THE INVENTION

Exemplary embodiments of the invention typically include methods of controlling access to a resource. Exemplary embodiments include creating a security object in dependence upon user-selected security control data types, including asserting security control data as security facts into a security knowledge database and asserting security rules into the security knowledge database, the security object including security control data and at least one security method. Such embodiments include receiving a request for access to the resource, receiving security request data, asserting the security request data as security facts into the security knowledge database, and determining access to the resource in dependence upon the security facts and security rules in the security knowledge database.

Exemplary embodiments typically include removing from the security knowledge database at least some of the security request data asserted as security facts. In such embodiments, creating a security object includes storing in the security object a resource identification for the resource, storing in the security object an authorization level of access for the resource, storing in the security object user-selected security control data types, and storing, in the security object, security control data for each user-selected security control data type. In exemplary embodiments, determining access includes authorizing a level of access in dependence upon the authorization level of access for the resource.

In exemplary embodiments, determining access to the resource typically includes inferring with an inference engine whether access is granted, the inferring carried out in dependence upon the security facts and security rules in the security knowledge database. Such embodiments include deploying the security object. Some embodiments include deploying the security object on a security server. Some embodiments include deploying the security object on a client device. In exemplary embodiments, the resource is located on a resource server. In some embodiments, the resource is located on a security server. In other embodiments, the resource is located on a client device.

In exemplary embodiments of the invention, the resource resides on a resource server. Such embodiments include deploying the security object on a security server. In exemplary embodiments receiving a request for access to the resource includes receiving the request for access to the resource in a security server from a client device across a network. In typical embodiments, the resource resides on a client device, and the client device has an application program. Such embodiments include deploying the security object on the client device. In exemplary embodiments, receiving a request for access to the resource includes receiving in the security object itself, the request for access to the resource as a call to the security method.

In exemplary embodiments, receiving a request for access to the resource includes calling the security method. In typical embodiments, receiving a request for access to the resource includes identifying the security object. In such embodiments, identifying the security object includes identifying the security object in dependence upon a URI. In exemplary embodiments, identifying the security object includes identifying the security object in dependence upon a URI that identifies the resource, including finding, in dependence upon the URI identifying the resource, an identification of the security object in an access control table.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIGS. 1a, 1b, and 1c set forth block diagrams depicting alternative exemplary data processing architectures useful in various embodiments of the present invention.

FIG. 2 sets forth a data flow diagram depicting exemplary methods of controlling access to a resource, including creating a security object and receiving a request for access to a resource, and determining whether to grant access to the resource.

FIG. 2a sets forth a data flow diagram depicting an exemplary method of inferring with an inference engine whether access is to be granted.

FIG. 3 sets forth a data flow diagram depicting an exemplary method of creating a security object.

FIG. 4 sets forth a class relations diagram including a security class, a security control class, and an inference engine.

FIG. 5 sets forth a data flow diagram depicting exemplary methods of receiving requests for access to resources.

### DETAILED DESCRIPTION OF EXEMPLARY EMBODIMENTS

### Introduction

The present invention is described to a large extent in this specification in terms of methods for securing valid authentication and authorization for access to computer resources and other items. Persons skilled in the art, however, will recognize that any computer system that includes suitable programming means for operating in accordance with the disclosed methods also falls well within the scope of the present invention.

Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product and stored on a diskette or other recording medium for use with any suitable data processing system.

Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Definitions

In this specification, the terms “field,” “data element,” and “attribute,” unless the context indicates otherwise, generally are used as synonyms, referring to individual elements of digital data. Aggregates of data elements are referred to as “records” or “data structures.” Aggregates of records are referred to as “tables” or “files.” Aggregates of files or tables are referred to as “databases.” Complex data structures that include member methods, functions, or software routines as well as data elements are referred to as “classes.” Instances of classes are referred to as “objects” or “class objects.”

“Browser” means a web browser, a communications application for locating and displaying web pages. Browsers typically comprise a markup language interpreter, web page display routines, and an HTTP communications client. Typical browsers today can display text, graphics, audio and video. Browsers are operative in web-enabled devices, including wireless web-enabled devices. Browsers in wireless web-enabled devices often are downsized browsers called “microbrowsers.” Microbrowsers in wireless web-enabled devices often support markup languages other than HTML, including for example, WML, the Wireless Markup Language.

“CORBA” means the Common Object Request Broker Architecture, a standard for remote procedure invocation first published by the Object Management Group (“OMG”) in 1991. CORBA can be considered a kind of object-oriented way of making “RPCs” or remote procedure calls, although CORBA supports many features that do not exist in RPC as such. CORBA uses a declarative language, the Interface Definition Language (“IDL”), to describe an object's interface. Interface descriptions in IDL are compiled to generate ‘stubs’ for the client side and ‘skeletons’ on the server side. Using this generated code, remote method invocations effected in object-oriented programming languages such as C++ and Java look like invocations of local member methods in local objects. Whenever a client program, such as, for example, a C++ program, acquires an object reference, decoded from a stringified object reference, from a Naming Service, or as a result from another method invocation, an ORB creates a stub object. Since a stub object cannot exist without an object reference, and an object reference rarely exists outside a stub object, these two terms are often used synonymously. For the server side, a skeleton is generated by the IDL compiler. A developer derives from that skeleton and adds implementation; an object instance of such an implementation class is called a ‘servant.’ The generated skeleton receives requests from the ORB, unmarshalls communicated parameters and other data, and performs upcalls into the developer-provided code. This way, the object implementation also looks like a ‘normal’ class.

“CGI” means “Common Gateway Interface,” a standard technology for data communications of resources between web servers and web clients. More specifically, CGI provides a standard interface between servers and server-side ‘gateway’ programs which administer actual reads and writes of data to and from file systems and databases. The CGI interface typically sends data to gateway programs through environment variables or as data to be read by the gateway programs through their standard inputs. Gateway programs typically return data through standard output.

“Client device” refers to any device, any automated computing machinery, capable of requesting access to a resource. Examples of client devices are personal computers, internet-enabled special purpose devices, internet-capable personal digital assistants, wireless handheld devices of all kinds, garage door openers, home security computers, thumbprint locks on briefcases, web-enabled devices generally, and handheld devices including telephones, laptop computers, handheld radios, and others that will occur to those of skill in the art. Various embodiments of client devices are capable of asserting requests for access to resources via wired and/or wireless couplings for data communications. The use as a client device of any instrument capable of a request for access to a resource is well within the present invention.

A “communications application” is any data communications software capable of operating couplings for data communications, including email clients, browsers, special purpose data communications systems, as well as any client application capable of accepting data downloads (downloads of security objects or resources, for example) via hardwired communications channels such as, for example, a Universal Serial Bus or ‘USB,’ downloads through wired or wireless networks, and downloads through other means as will occur to those of skill in the art. In typical embodiments of the present invention, communications applications run on client devices.

“Coupled for data communications” means any form of data communications, wireless, infrared, radio, internet protocols, HTTP protocols, email protocols, networked, direct connections, dedicated phone lines, dial-ups, and other forms of data communications as will occur to those of skill in the art.

“DCOM” means ‘Distributed Component Object Model,’ an extension of Microsoft's Component Object Model (“COM”) to support objects distributed across networks. DCOM is part of certain Microsoft operating systems, including Windows NT, and is available for other operating systems. DCOM serves the same purpose as IBM's DSOM protocol, which is a popular implementation of CORBA. Unlike CORBA, which runs on many operating systems, DCOM is currently implemented only for Windows.

“GUI” means graphical user interface.

“HTML” stands for ‘HyperText Markup Language,’ a standard markup language for displaying web pages on browsers.

“HTTP” stands for ‘HyperText Transport Protocol,’ the standard data communications protocol of the World Wide Web.

A “hyperlink,” also referred to as “link” or “web link,” is a reference to a resource name or network address which when invoked allows the named resource or network address to be accessed. More particularly in terms of the present invention, invoking a hyperlink implements a request for access to a resource. Often a hyperlink identifies a network address at which is stored a resource such as a web page or other document. As used here, “hyperlink” is a broader term than “HTML anchor element.” Hyperlinks include links effected through anchors as well as URIs invoked through ‘back’ buttons on browsers, which do not involve anchors. Hyperlinks include URIs typed into address fields on browsers and invoked by a ‘Go’ button, also not involving anchors. In addition, although there is a natural tendency to think of hyperlinks as retrieving web pages, their use is broader than that. In fact, hyperlinks access “resources” generally available through hyperlinks including not only web pages but many other kinds of data and server-side script output, servlet output, CGI output, and so on.

“LAN” means local area network.

“Network” is used in this specification to mean any networked coupling for data communications among computers or computer systems. Examples of networks useful with the invention include intranets, extranets, internets, local area networks, wide area networks, and other network arrangements as will occur to those of skill in the art.

An “ORB” is a CORBA Object Request Broker.

“Resource” means any information or physical item access to which is controlled by security objects of the present invention. Resources often comprise information in a form capable of being identified by a URI or URL. In fact, the ‘R’ in ‘URI’ is ‘Resource.’ The most common kind of resource is a file, but resources include dynamically-generated query results, the output of CGI scripts, dynamic server pages, documents available in several languages, as well as physical objects such as garage doors, briefcases, and so on. It may sometimes be useful to think of a resource as similar to a file, but more general in nature. Files as resources include web pages, graphic image files, video clip files, audio clip files, and so on. As a practical matter, most HTTP resources are currently either files or server-side script output. Server side script output includes output from CGI programs, Java servlets, Active Server Pages, Java Server Pages, and so on.

“RMI,” or “Java RMI,” means ‘Remote Method Invocation,’ referring to a set of protocols that enable Java objects to communicate remotely with other Java objects. RMI's structure and operation is somewhat like CORBA's, with stubs and skeletons, and references to remotely located objects. In comparison with other remote invocations protocols such as CORBA and DCOM, however, RMI is relatively simple. RMI, however, works only with Java objects, while CORBA and DCOM are designed to support objects created in any language.

“Server” in this specification refers to a computer or device comprising automated computing machinery on a network that manages resources and requests for access to resources. A “security server” can be any server that manages access to resources by use of security objects according to the present invention. A “web server,” or “HTTP server,” in particular is a server that communicates with browsers by means of HTTP in order to manage and make available to networked computers documents in markup languages like HTML, digital objects, and other resources.

A “Servlet,” like an applet, is a program designed to be run from another program rather than directly from an operating system. “Servlets” in particular are designed to be run on servers from a conventional Java interface for servlets. Servlets are modules that extend request/response oriented servers, such as Java-enabled web servers. Java servlets are an alternative to CGI programs. The biggest difference between the two is that a Java servlet is persistent. Once a servlet is started, it stays in memory and can fulfill multiple requests. In contrast, a CGI program disappears after it has executed once, fulfilling only a single a request for each load and run. The persistence of Java servlets makes them generally faster than CGI because no time is spent on loading servlets for invocations after a first one.

A “URI” or “Universal Resource Identifier” is an identifier of a named object in any namespace accessible through a network. URIs are functional for any access scheme, including for example, the File Transfer Protocol or “FTP,” Gopher, and the web. A URI as used in typical embodiments of the present invention usually includes an internet protocol address, or a domain name that resolves to an internet protocol address, identifying a location where a resource, particularly a web page, a CGI script, or a servlet, is located on a network, usually the Internet. URIs directed to particular resources, such as particular HTML files or servlets, typically include a path name or file name locating and identifying a particular resource in a file system coupled through a server to a network. To the extent that a particular resource, such as a CGI file or a servlet, is executable, for example to store or retrieve data, a URI often includes query parameters, or data to be stored, in the form of data encoded into the URI. Such parameters or data to be stored are referred to as ‘URI encoded data.’

“URLs” or “Universal Resource Locators” comprise a kind of subset of URIs, wherein each URL resolves to a network address. That is, URIs and URLs are distinguished in that URIs identify named objects in namespaces, where the names may or may not resolve to addresses, while URLs do resolve to addresses. Although standards today are written on the basis of URIs, it is still common to such see web-related identifiers, of the kind used to associate web data locations with network addresses for data communications, referred to as “URLs.” This specification refers to such identifiers generally as URIs.

“WAN” means ‘wide area network.’ One example of a WAN is the Internet.

“World Wide Web,” or more simply “the web,” refers to a system of internet protocol (“IP”) servers that support specially formatted documents, documents formatted in markup languages such as HTML, XML (eXtensible Markup Language), WML (Wireless Markup Language), or HDML (Handheld Device Markup Language). The term “Web” is used in this specification also to refer to any server or connected group or interconnected groups of servers that implement a hyperlinking protocol, such as HTTP or WAP (the ‘Wireless Access Protocol’), in support of URIs and documents in markup languages, regardless of whether such servers or groups of servers are coupled to the World Wide Web as such.

### DETAILED DESCRIPTION

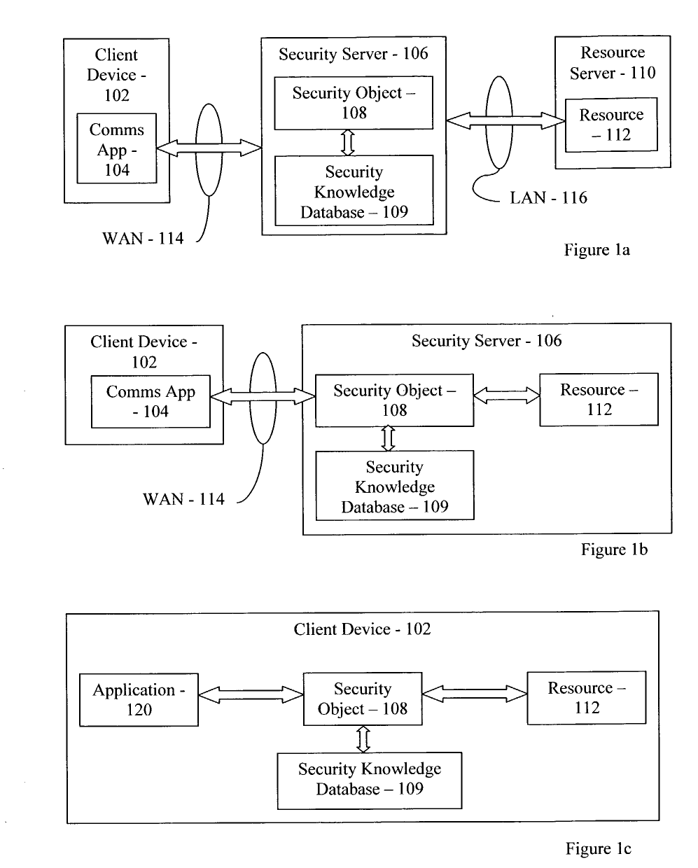

Embodiments of the present invention provide security objects for improving the administration of controlling access to secured resources. FIGS. 1a, 1b, and 1c set forth block diagrams depicting alternative exemplary data processing architectures useful in various embodiments of the present invention.

As illustrated in FIG. 1a, some embodiments of the present invention deploy security objects (108) in security servers (106) coupled for data communications through LANs (116) to resource servers (110) upon which resources (112) are stored. Embodiments according to FIG. 1a typically include a security knowledge database (109) that stores security facts and security rules for use by a security object (108). The security knowledge database (109) in some embodiments resides on a security server (106). In other embodiments a security knowledge database (109) is treated like other resources (112) and stored on a resource server (110). Any storage arrangement for a security knowledge database, as will occur to those of skill in the art is well within the scope of the present invention. Security servers (106) according to FIG. 1a typically are coupled for data communications to client devices (102) through networks such as WANs (114) or LANs (116). Data communications between client devices and security servers in such architectures are typically administered by communications applications (104), including, for example, browsers. WANs include internets and in particular the World Wide Web. Client devices (102) are defined in detail above and include any automated computing machinery capable of accepting user inputs through a user interface and carrying out data communications with a security server. A “security server” is any server that manages access to resources by use of security objects according to the present invention.

As illustrated in FIG. 1b, some embodiments of the present invention deploy security objects (108) in security servers (106) upon which are stored secured resources (112). Embodiments according to FIG. 1b also typically include a security knowledge database (109) for use by a security object (108). The architecture of FIG. 1b illustrates that resources (112, 109) can be stored on the same server (106) that secures access to the resources. In all this discussion, the term ‘security server’ refers to any server that manages access to resources by use of security objects according to the present invention. There is no limitation that a ‘security server’ as the term is used in this disclosure must provide other security services, or indeed that a security server must provide any security services whatsoever, other than managing access to resources through security objects. FIGS. 1a and 1b show security objects deployed in or upon security servers, but having security objects deployed upon it is not a requirement for a server to be considered a security server within the usage of this disclosure. Security objects may be deployed anywhere on a network or on client devices. If a server manages access to resources by use of security objects, regardless where the security objects are located, then that server is considered a ‘security server’ in the terminology of this disclosure. Some ‘security servers’ of the present invention, as described in more detail below, are ordinary web servers modified somewhat to support lookups in access control tables. Many ‘security servers’ of the present invention, however, are ordinary unmodified web servers or Java web servers, designated as ‘security servers’ only because they manage access to resources by use of security objects, security objects which may or may not be installed upon those same servers.

As shown in FIG. 1c, some embodiments deploy security objects (108) in client devices (102) which themselves also contain both the applications software (120) concerned with accessing the resources and also the resources (112) themselves. Embodiments according to FIG. 1c also typically include a security knowledge database (109) for use by a security object (108). This architecture includes devices in which a security object may be created on a more powerful machine and then downloaded to a less powerful machine. The less powerful machine then often is associated one-to-one with a single resource, or is used to secure a relatively small number of resources. One example of this kind of embodiment includes a garage door opener in which a security application program (120) is implemented as an assembly language program on a tiny microprocessor or microcontroller and the secured resource is a motor that operates a garage door. Another example is a briefcase fitted with a microprocessor or microcontroller, a fingerprint reader, and a USB port through which is downloaded a security object that controls access to a resource, an electromechanical lock on the briefcase.

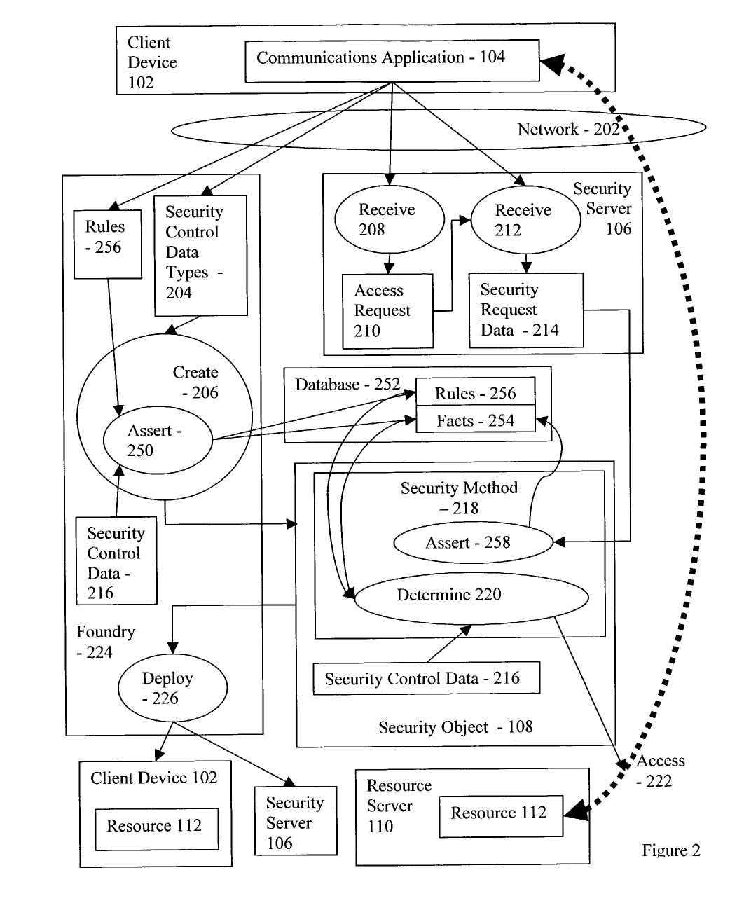

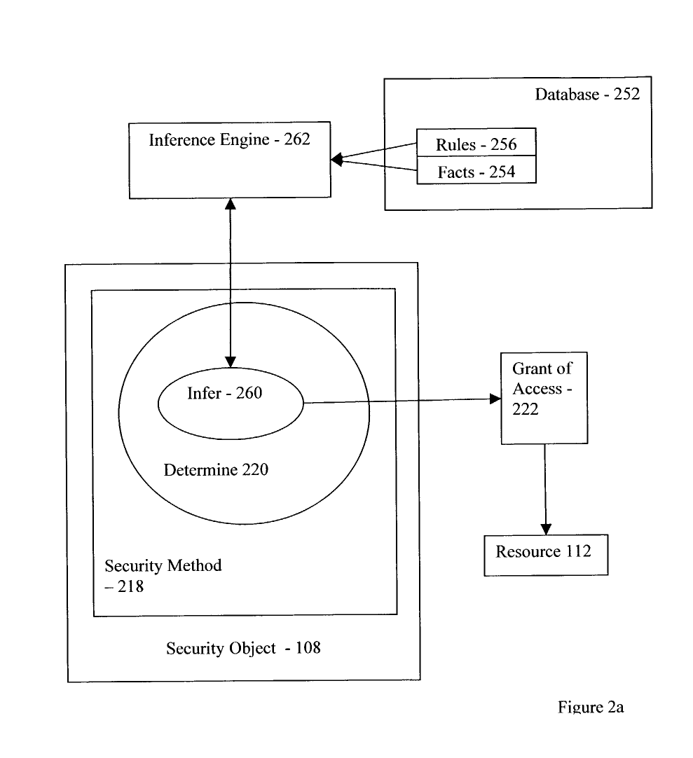

FIG. 2 sets forth a data flow diagram depicting an exemplary method of controlling access to a resource (112). The method of FIG. 2 includes creating (206) a security object (108) in dependence upon user-selected security control data types (204), the security object comprising security control data (216). The process of creating (206) a security object (108) includes asserting (250) security control data (216) as security facts (254) into a security knowledge database (252) and asserting (250) security rules (256) into a security knowledge database (252),

In general, a knowledge base is a centralized repository for information: a public library or a database of related information about a particular subject can both be considered examples of knowledge bases. In relation to computer technology, a knowledge base is a machine-readable resource for the dissemination of information, generally online or with the capacity to be put online. This specification discloses a particular example of a knowledge base as a security knowledge database.

In this example, the exemplary knowledge base, that is, the security knowledge database, is implemented as a database of Prolog clauses comprising security facts and security rules. Prolog is a high-level programming language based on formal logic. Unlike traditional programming languages that are based on performing sequences of commands, Prolog is based on defining and then solving logical formulas. Prolog is sometimes called a declarative language or a rule-based language because its programs comprise lists of facts and rules. Facts and rules comprising Prolog programs are often stored in program files referred to as Prolog databases. A Prolog database comprising factual assertions and logical rules is correctly viewed as a knowledge base. In this disclosure, the utilization of Prolog is exemplary, not a requirement of the present invention. In addition to Prolog, many methods and means, and many computer languages, will occur to those of skill in the art for establishing knowledge bases, and all such methods, means, and languages are well within the scope of the present invention.

In the example of Prolog, a knowledge base, in this discussion, a security knowledge database, comprises Prolog clauses including facts and rules. In this disclosure, facts in a security knowledge database are referred to as ‘security facts,’ and rules in a security knowledge database are referred to as ‘security rules.’ Storing facts and rules in a security knowledge database is referred to as ‘asserting’ security facts and security rules. Conversely, security facts and security rules can be removed from a security knowledge database by ‘retracting’ them.

Security facts and security rules typically have a form similar to so-called predicate logic. For example, the following is a valid set of three Prolog clauses:

parent(fred, greta).

parent(greta, henry).

grandparent(X, Z):—parent(X, Y), parent(Y, Z).

Prolog clauses are normally of three types: Facts declare things that are always true. Rules declare things that are true depending on a given condition. Questions are used to find out if a particular goal is true. Prolog questions are sometimes referred to as ‘goals’ or ‘queries.’ In the three-line example above, “parent(fred, greta) is a fact. “Parent” is a predicate. “Fred” is the first argument, sometimes called a ‘subject.’ “Greta” is the second argument, sometimes called an ‘object.’

In the three-line example above, “grandparent(X, Z):—parent(X, Y), parent(Y, Z).” is a rule. “Grandparent(X,Z)” is referred to as the ‘head’ of the rule. “Parent(X, Y), parent(Y, Z)” is referred to as the ‘body’ of the rule. “Parent(X, Y)” is the first subgoal of the rule. “Parent(Y, Z)” is the second subgoal of the rule. X, Y, and Z are variables.

This example rule is correctly described in several ways. One declarative description is: For all X and Z, X is a grandparent of Z if there exists some Y such that X is a parent of Y and Y is a parent of Z. Another declarative description is: For all X, Y and Z, if X is a parent of Y and Y is a parent of Z then X is a grandparent of Z. A procedural interpretation of the rule is: The goal grandparent(X, Z) succeeds with binding X1 for X and and binding Z1 for Z if first, the goal parent(X, Y) succeeds with bindings X1 and Y1 and then the goal parent(Y, Z) succeeds with bindings Y1 and Z1.

An “inference engine” generally is a computer program that uses rules of logic to derive output from a knowledge base. As discussed in more detail below, an inference engine can comprise a Prolog database of Prolog clauses and can be operated by submitting Prolog queries or goals. In this disclosure, “inference engine” refers to software providing a functional interface for queries to a security knowledge database.

A Prolog goal is said to ‘succeed’ if it can be satisfied from a set of clauses in a Prolog database. A goal fails if it cannot be so satisfied. For an example based upon the three-line set of example Prolog clauses set forth above: the query “grandparent(fred, X).” is satisfied with X instantiated to henry. On the other hand, the query “grandparent(fred, bob).” is not capable of being satisfied from three-line exemplary Prolog database, because ‘bob’ does not appear in that set of clauses.

As a further aid to understanding, consider the following example Prolog program, an example that is more closely related to computer security.

userID(“SCD”, myFile, fred).
userID(“SRD”, myFile, fred).
password(“SCD”, myFile, fred, pw001).
password(“SRD”, myFile, fred, pw001).
userID(“SCD”, myFile, greta).
userID(“SRD”, myFile, greta).
password(“SCD”, myFile, greta, pw002).
password(“SRD”, myFile, greta, pw002).

| | |
|---|---|
| grantAccess(ResourceID):- | userID(“SCD”, ResourceID, X), |
| | userID(“SRD”, ResourceID, X), |
| | password(“SCD”, ResourceID, X, Y), |
| | password(“SRD”, ResourceID, X, Y). |

This example is a Prolog program or database with eight facts and one rule. The facts are these:

fred is a userID asserted as security control data (“SCD”) for access to a resource named ‘myFile’

fred as a userID has been asserted as security request data (“SRD”) for access to myFile

fred has a password, pw001, asserted as security control data for access to myFile

fred's password, pw001, has been asserted as security request data for access to myFile

greta is a userID asserted as security control data for access to myFile greta as a userID has been asserted as security request data for access to myFile

greta has a password, pw002, asserted as security control data for access to myFile

greta's password, pw002, has been asserted as security request data for access to myFile

The example rule:

| | |
|---|---|
| grantAccess(ResourceID):- | userID(“SCD”, ResourceID, X), |
| | userID(“SRD”, ResourceID, X), |
| | password(“SCD”, ResourceID, X, Y), |
| | password(“SRD”, ResourceID, X, Y). |

says that the query ‘grantAccess(“myFile”)’ succeeds when security control data and security request data for a password and a userID for myFile have been asserted, that is, are present in the Prolog clauses in the Prolog database. In this example, ‘grantAccess(“someotherFile”)’ fails because there are no security facts asserted in support of access to a resource named ‘someOtherFile.’ The query ‘grantAccess(“myFile”), however, succeeds because these security facts are asserted among the example Prolog clauses:

userID(“SCD”, myFile, fred).

userID(“SRD”, myFile, fred).

password(“SCD”, myFile, fred, pw001).

password(“SRD”, myFile, fred, pw001).

Note that it is also sufficient for the success of the query ‘grantAccess(“myFile”)’ that these four security facts are asserted:

userID(“SCD”, myFile, greta).

userID(“SRD”, myFile, greta).

password(“SCD”, myFile, greta, pw002).

password(“SRD”, myFile, greta, pw002).

This is true because the query contains no limitation regarding userID. Whether the query succeeds because fred is authorized access or because greta is authorized access is ambiguous. In implementing security objects according to embodiments of the present invention, it is considered advantageous to reduce the risk of such ambiguity. One way of reducing such ambiguity is to limit the number of allowed assertions of security request data to one set at a time. Consider the following example, in which security request data is asserted only for fred:

userID(“SCD”, myFile, fred).
userID(“SRD”, myFile, fred).
password(“SCD”, myFile, pw001).
password(“SRD”, myFile, pw001).
userID(“SCD”, myFile, greta).
password(“SCD”, myFile, pw002).

| | |
|---|---|
| grantAccess(ResourceID):- | userID(“SCD”, ResourceID, X), |
| | userID(“SRD”, ResourceID, X), |
| | password(“SCD”, ResourceID, Y), |
| | password(“SRD”, ResourceID, Y). |

For this example, the query ‘grantAccess(“myFile”)’ succeeds only because there is both security control data and security request data for fred. There is security control data for greta, but no security request data for greta. In other words, the second and fourth subgoals of the rule cannot succeed for greta because there are no “SRD” clauses for greta among the asserted security facts.

It is useful to note also that the data structure changed for the password clauses. In this second example, the one just above, because only one set of security request data is present at any one time, there is no need to keep a bound password variable for use in resolving the last two subgoals of the rule. In other words, for a given resource, the only SRD clauses that can satisfy the rule are the SRD clauses that correspond with the SCD clauses. That is, when only one set of SRD data is allowed in the knowledge base at a time, then the resourceID is all the indexing needed to identify the pertinent security facts for use in resolving the rule.

In order to maintain this less ambiguous state of affairs among embodiments of the present invention, it is advantageous to remove security request data from the knowledge base after each usage. As described below, one exemplary way of removing asserted security request data from a knowledge base such as a Prolog database is by use of the conventional, built-in ‘retract’ function of Prolog.

The ‘retract’ built-in predicate of Prolog is one way mentioned only as an example and not as a limitation. Another way to disambiguate queries when more than one user has present assertions of both security control data and security request data is to add a userID to the rule and to the query, such as, for example, grantAccess(ResourceID, UserID). This disclosure has now set forth two example methods of reducing ambiguity of queries. Persons of skill in the art will think of other means and methods for reducing ambiguity of queries against security knowledge databases, and all such means and methods are well within the scope of the present invention.

In this disclosure, application programs that administer the creation of security objects are called ‘foundries.’ In typical embodiments according to FIG. 2, a foundry (224) prompts a user through a user interface displayed on a client device (102) to select one or more security control data types through, for example, use of a menu similar to this one:

Please select a security control data type:

1. User Logon ID

2. Password

3. Fingerprint

4. Voice Recognition

5. Retinal Scan

Your selection (1-5): ______

The foundry (224) creates (206) the security object (108) in dependence upon the user's selections of security control data types in the sense that the foundry aggregates into, or associates by reference, the security object security control data types according to the user's selection. If, for example, the user selects menu item 1 for a user logon ID, the foundry causes a security control data type to be included in the security object for administration of a user logon ID. If the user selects menu item 2 for a password, the foundry causes a security control data type to be included in the security object for administration of a password. If the user selects menu item 3 for a fingerprint, the foundry causes a security control data type to be included in the security object for administration of fingerprints. And so on for voice recognition technology, retinal scans, and any other kind of security control data amenable to administration by electronic digital computers.

In typical embodiments of the present invention, as shown in FIG. 2, a security object (108) includes at least one security method (218). In this disclosure, ‘security method’ means an object oriented member method. The security method typically is a software routine called for validating or determining whether to grant access to a resource and what level of authorization to grant. As discussed in more detail below, the security method can have various names depending on how the security object is implemented, ‘main( )’ for security objects to be invoked with Java commands, ‘security( )’ for servlets, and so on. These exemplary names are for clarity of explanation only, not for limitation. In many forms of security object, the name chosen for the security method is of no concern whatsoever.

Embodiments according to FIG. 2 include receiving (208) a request (210) for access to the resource and receiving a request for access to a resource can be implemented as a call to a security method in a security object. A security object implemented in Java, for example, can have a main( ) method called by invocation of the security object itself, as in calling ‘java MySecurityObject,’ resulting in a call to MySecurityObject.main( ). This call to main( ) is in many embodiments itself receipt of a request for access to the resource secured by use of the security object.

The method of FIG. 2 includes receiving (212) security request data (214). Continuing with the example of a security object called ‘MySecurityObject,’ the security object's member security method can prompt the user, or cause the user to be prompted, for security request data in dependence upon the security control data types in use in the security object. That is, if the security object contains security control data of type ‘User Logon ID,’ then the security method causes the user to be prompted to enter security request data, expecting the security request data received to be a user logon ID. If the security object contains security control data of type ‘Password,’ then the security method causes the user to be prompted to enter security request data, expecting the security request data received to be a password. If the security object contains security control data of type ‘Fingerprint,’ then the security method causes the user to be prompted to enter security request data, expecting the security request data received to be a digital representation of a fingerprint. The security method in such embodiments typically does not include in its prompt to the user any identification of the security control data type expected. This is, after all, a security system. If the user does not know that the user must provide in response to a first prompt a password and in response to a second prompt a thumbprint in order to gain access to a particular resource, then the user probably ought not gain access to the resource.

The method of FIG. 2 includes asserting (250) the security request data (214) as security facts (254) into the security knowledge database (252). As described in more detail below, security objects typically associate by reference one or more security control objects having member methods that carry out the actual details of prompting for and receiving security request data. Calls from a security object's security method to member methods in security control objects are what is meant by saying that a security method “causes” a user to be prompted for security request data. Security control objects also typically carry out the detail work of asserting security request data as security facts into a security knowledge database.

The method of FIG. 2 includes determining (220) access (222) to the resource in dependence upon security facts (254) and security rules (256) in a security knowledge database (252). More particularly, determining access means determining whether to grant access and what kind of access is to be granted. Generally in this disclosure, whether to grant access to a particular user is referred to as ‘authentication,’ and the kind of access granted is referred to as ‘authorization level.’ Determining whether to grant access typically includes determining whether security request data provided by a user in connection with a request for access to a resource matches corresponding security control data. That is, in the example of a password, determining whether to grant access includes determining whether a password provided as security request data matches a password stored in aggregation with a security object as security control data. In the example of a thumbprint, determining whether to grant access includes determining whether a thumbprint provided as security request data matches a thumbprint stored in aggregation with a security object as security control data. And so on. Authorization levels include authorization to read a resource, authorization to write to a resource (which typically includes ‘edit’ authority and ‘delete’ authority), and authorization to execute a resource (for which one ordinarily needs an executable resource).

As illustrated in FIG. 2a, determining (220) access to a resource (112), in typical embodiments of the present invention, includes inferring (260) with an inference engine (262) whether access (222) is to be granted. The inferring (260) typically is carried out in dependence upon the security facts (254) and security rules (256) in a security knowledge database (252). In the exemplary embodiments described in this disclosure, inferring (260) is carried out through calls to an inference engine implemented as a database interface class, described in detail below in this disclosure.

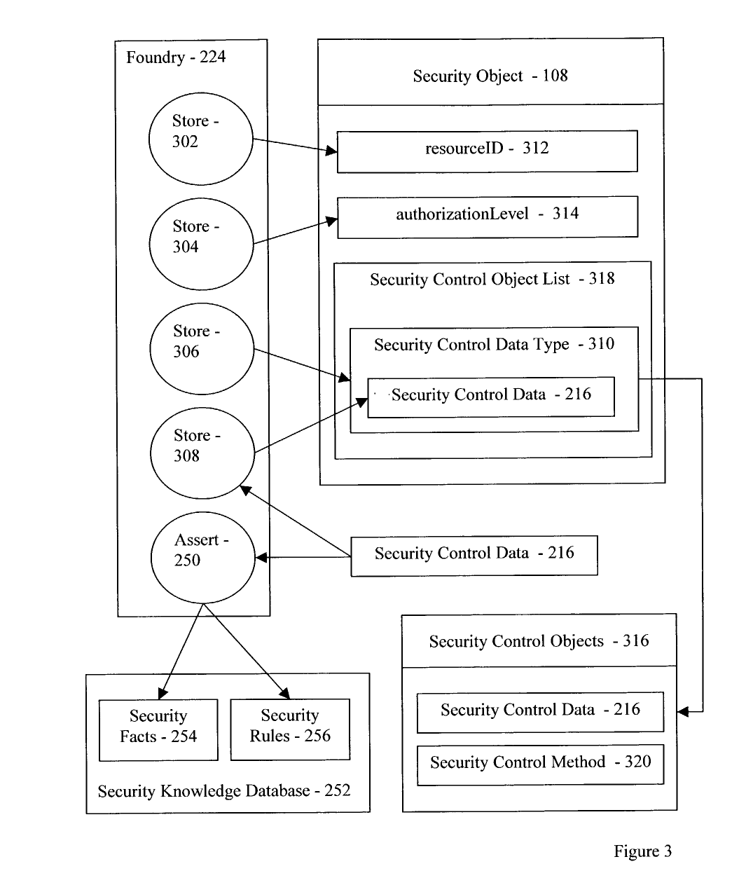

FIG. 3 sets forth a data flow diagram depicting an exemplary method of creating a security object. In other words, the method depicted in FIG. 3 drills down on what it means to create a security object in a foundry of the present invention. In the method of FIG. 3 creating a security object is shown to include storing (302) in the security object (108) a resource identification (312) for the resource. In other words, the foundry prompts the user to enter a filename, pathname, URL, URI, or any useful means as will occur to those of skill in the art for identifying a resource to be secured by the security object. In this example, the foundry then stores (302) the identification of the resource in a member field called ‘resourceID’ (312) in the security object itself.

In the method of FIG. 3 creating a security object includes storing (304) in the security object (108) an authorization level (314) of access for the resource. In other words, the foundry prompts the user to enter an authorization level, ‘read,’ ‘write,’ or ‘execute,’ for example, and then stores (304) the authorization level in a member field named ‘authorizationLevel’ (314) in the security object itself.

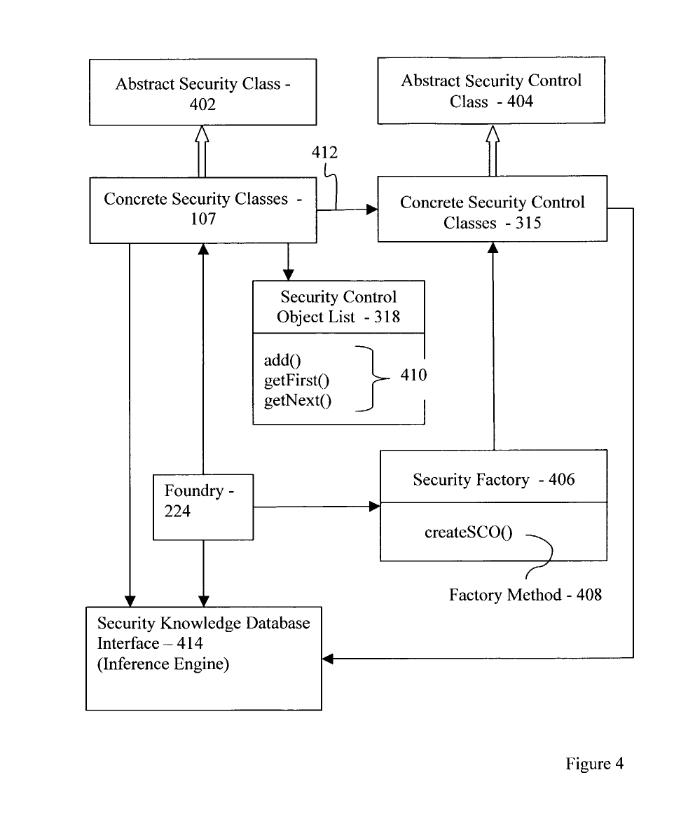

In the method of FIG. 3, creating a security object includes storing (306) in the security object (108) user-selected security control data types (310). More particularly, in the method of FIG. 3, security control data types (310) are stored as references to security control objects (316). Security control data types (310) in fact are security control classes (404 on FIG. 4) from which security control objects are instantiated. Storing (306) user-selected security control data types comprises storing references to security control objects (316) in a security control object list (318) in the security object (108), including instantiating a security control object (316) of a security control class in dependence upon security control data type. That is, if the security control data type is a password, then the foundry causes to be instantiated from a password security control class a password security control object, storing in the security control object list (318) a reference to the password security control object. Similarly, if the security control data type is a fingerprint, then the foundry causes to be instantiated from a fingerprint security control class a fingerprint security control object, storing in the security control object list (318) a reference to the fingerprint security control object. And so on.

The security control object list (318) itself is typically implemented as a container object from a standard library in, for example, C++ or Java. That is, the security control object list (318) is typically a class object aggregated by reference to the security object (108).

In the method of FIG. 3, creating a security object includes storing (308) in the security object security control data (216) for each user-selected security control data type (310). Instantiating a security control object (316) calls a constructor for the security control object. In some embodiments, it is the constructor that prompts for security control data of the type associated with the security control object. That is, if the security control data object is a password security control object, its constructor prompts for a password to be stored (308) as security control data (216). Similarly, if the security control data object is a thumbprint security control object, its constructor prompts for a thumbprint to be stored (308) as security control data (216). And so on. Also in the method of FIG. 3, creating a security object includes asserting (250) security control data (216) as security facts (254) into a security knowledge database (252) and asserting (250) security rules (256) into a security knowledge database (252).

In architectures similar to those illustrated in FIGS. 1a and 1b in which a client device (102) is located remotely across a network (114) from a security server (106) upon which security control data is to be stored (308), the security control data advantageously is communicated across the network from the client device to the security server in encrypted form. One example of such encrypted communications is network messaging by use of ‘SSL,’ that is, communications connections through a ‘Secure Sockets Layer,’ a known security protocol for use in internet protocol (“IP”) networks, in which encryption of message packets is provided as a standard communications service. In addition to encrypted communications of security control data, at least some elements of security control data, such as, for example, passwords, also are advantageously stored (308) in encrypted form.

Even more particularly, foundries according to the present invention may be implemented and operated in accordance with the following pseudocode.

Class Foundry {

private String selectionText =

```
“Please select a security control data type:
    1. Password
    2. Fingerprint
    3. Voice Recognition
Your selection (1-3):  ”
```

void main( ) {

// create security object
SecurityClass SO = new SecurityClass( );
// identify resource secured by the new security object
Resource resourceID =

getResourceID(“Please enter resource ID: ”);

// store resource ID in security object
SO.setResource(resourceID);
// prompt for authorization level
char authorizationLevel =

getAuthorizationLevel(“Please enter authorization
level: ”);

// store authorization level in security object
SO.setAuthorizationLevel(authorizationLevel);
// get a first ‘SCD-Type,’ Security Control Data Type
SCD-Type = getUserSelection(selectionText);
// create container for a security rule
String SecurityRule = “grantAccess(resourceID) :-”;
// instantiate interface to security knowledge database
DatabaseInterface DBIF = new DatabaseInterface( );
while(SCD-Type != null) {

// based on SCD-Type, create Security Control Object
SCO = SCO-Factory.createSCO(SCD-Type, resourceID);
// store security control data in the security control object,
// assert security control data as security fact, and
// concatenate rule fragments into a security rule
SecurityRule += SCO.setSecurityControlData(resourceID);
// add new SCO to the list in the Security Object
SO.add(SCO);
// get another SCD-Type, as many as user wants
SCD-Type = getUserSelection(selectionText);

} // end while( )
// assert security rule into security knowledge database
DBIF.assert(SecurityRule, resourceID);

} // end main( )

} // end Foundry

With reference to FIGS. 2 and 3, the pseudocode foundry creates (206) a security object (108) by instantiating a security class:

SecurityClass SO=new SecurityClass( ).

The pseudocode foundry then stores (302) a resource identification (312) through:

Resource resourceID=getResourceID(“Please enter resource ID: ______”);

SO.setResource(resourceID);

The call to SO.setResource( ) is a call to a member method in the security object described in more detail below. The pseudocode foundry stores (304) an authorization level (314) through:

char authorizationLevel=getAuthorizationLevel(“Please enter authorization level: ______”);

SO.setAuthorizationLevel(authorizationLevel);

The call to SO.setAuthoriztionLevel( ) is a call to a member method in the security object described in more detail below.

The pseudocode foundry stores (306) security control data types (310) by repeated calls to SO.add(SCO). SO.add( ) is a member method in the security object that adds security control objects to a list in the security object as described in more detail below.

The pseudocode foundry stores (308) security control data (216) in the security object (108) by repeated calls to SCO.setSecurityControlData( ). SCO.setSecurityControlData( ) is a member method in a security control object (316) that prompts for and stores a type of security data with which the security control object is associated, fingerprints for fingerprint security control object, passwords for password security control objects, and so on. A separate security control object is created for each security control data type selected or request by the user in response to getUserSelection(selectionText).

SCO.setSecurityControlData( ) also carries out the step of asserting (250) security control data (216) as security facts (254) into a security knowledge database (252). In addition, SCO.setSecurityControlData( ) returns a fragment of a security rule appropriate to the security control data type represented by the security control object SCO. When, for example, the SCO is for a userID, the rule fragment returned is of the kind illustrated by:

```
                    userID(“SCD”, X), userID(“SRD”, X).
In this way, the line:
            String SecurityRule = “grantAccess(resourceID) :-”;
begins construction of a security rule, and concatenation through the line:
                SecurityRule += SCO.setSecurityControlData( );
```

continues construction of the security rule by appending an appropriate rule fragment from each security control object created in the while( ) loop. If, for example, a user so creates security control objects for a userID, a password, and a Global Positioning System (“GPS”) location, then the corresponding rule fragments returned by SCO.setSecurityControlData( ) would be:

userID(“SCD”, X), userID(“SRD”, X),

password(“SCD”, Y), password(“SRD”, Y),

gps(“SCD”, Z), gps(“SRD”, Z).

After concatentation with the initial value of SecurityRule, “grantAccess(resourceID):—”, the resulting security rule for this example is:

| | |
|---|---|
| grantAccess(resourceID) :- | userID(“SCD”, X), userID(“SRD”, X), |
| | password(“SCD”, Y), password(“SRD”, Y), |
| | gps(“SCD”, Z), gps(“SRD”, Z). |

In cases requiring deeper comparison, such as, for example, bitwise comparisons of digital images such as retinal images or fingerprint, modern implementations of Prolog support programmer-defined functions or predicates for that purpose. The following clause, for example, succeeds if there exists in the security knowledge database a retinal scan as security control data X and a retinal scan as security request data Y such that X and Y successfully compare bitwise:

retina(“SCD”, X), retina(“SRD”, Y), bitwiseCompare(X, Y).

The predicate bitwiseCompare(X, Y) is a programmer-defined function that operates like other Prolog predicates in that it returns true if X and Y compare successfully and false if they do not. X and Y are bound to filenames by the first two subgoals: retina(“SCD”, X), retina(“SRD”, Y), and bitwiseCompare(X, Y) is programmed to open the two files and perform a bitwise comparison. If, for example, a user creates security control objects for a userID, a password, and a retinal scan, then the corresponding rule fragments returned by SCO.setSecurityControlData( ) could be:

grantAccess(resourceID):—

userID(“SCD”, A), userID(“SRD”, A),

password(“SCD”, B), password(“SRD”, B),

retina(“SCD”, X), retina(“SRD”, Y), bitwiseCompare(X, Y).

After complete construction of SecurityRule, that is, after the while( ) loop in the Foundry.main( ), the pseudocode foundry proceeds by asserting SecurityRule into a security knowledge database by the call:

DBIF.assert(SecurityRule, resourceID);

“DBID” is a reference to a class that implements an interface to a security knowledge database, instantiated in this example by:

“DatabaseInterface DBIF=new DatabaseInterface( );”.

An example of a class that implements an interface to a security knowledge database is described in more detail below.

Each time the user selects a new security control data type, the foundry creates a new security control object by calling a factory method in a security control object factory. The security control object factory is a class called SCO-Factory, and the factory method is SCO-Factory.createSCO( ). The calls to SCO.setSecurityControlData( ) are polymorphic calls, each of which typically accesses a different security control object although exactly the same line of code is used for each such call. In this elegant solution, the foundry itself never knows or cares which security control data types are implemented, what security control data is stored in security objects it creates, or what security facts and security rules are asserted into security knowledge databases.

Readers of skill in the art may notice that the foundry could be made even leaner by allowing security control object constructors to carry out the work of SCO.setSecurityControlData( ). In this example, however, for clarity of explanation of the operation of the foundry, SCO.setSecurityControlData( ) is left at the foundry level so that the effects of foundry operations are more fully exposed by the foundry itself.

The process of creating security control objects can be carried out as illustrated in the following pseudocode example of a factory class:

//
// Security Control Object Factory Class
//
// Defines a parameterized factory method for creating security
control objects
//
class SCO-Factory {

public static SecurityControlClass createSCO(SCD-Type, resourceID)
{

// establish null reference to new Security Control Object
SecurityControlClass SecurityControlObject = null;
switch(SCD-Type) {

case LOGONID:

```
SecurityControlObject =
  new LogonIDSecurityControlClass(resourcerID);
  break;
```

case PASSWORD:

```
SecurityControlObject =
  new PasswordSecurityControlClass(resourcerID);
  break;
```

case FINGERPRINT:

```
SecurityControlObject =
  new FingerprintSecurityControlClass(resourcerID);
  break;
```

| | |
|---|---|
| ... ... ... | // Can have many security control data types, |
| | // not merely these five |

case RETINA:

```
SecurityControlObject =
  new RetinaSecurityControlClass(resourcerID);
  break;
```

case GPS:

SecurityControlObject =
new GPSSecurityControlClass(resourcerID); break;

} // end switch( )
return SecurityControlObject;

} // end createSCO ( )

} // end class SCO-Factory

The factory class implements the createSCO( ) method, which is a so-called parameterized factory method. CreateSCO( ) accepts as a parameter the security control data type ‘SCD-Type’ of the security control data to be administered by a security control object. CreateSCO( ) then operates a switch( ) statement in dependence upon SCD-Type to decide exactly which security control class to instantiate depending on which type of security control data is needed—logon IDs, passwords, fingerprints, voice identifications, and so on. Although only four security control data types are illustrated in the factory class (logon IDs, passwords, fingerprints, and retinal scans), in fact the factory can create and return to the calling foundry a security control object for any type of security control data supported by the security system in which it is installed, that is, any type of security control object for which a security control data type or class (404) is defined.

Security control objects can be instantiated from a security control class according to the following pseudocode security control class:

//
// abstract SecurityControlClass
//
Abstract Class SecurityControlClass {

public void setSecurityControlData(resourceID) {

String SecurityControlData =

prompt( “Please enter security control data: );

DatabaseInterface DBIF = new DatabaseInterface( );
DBIF.assert(SecurityControlData, resourceID);
return(String/* security rule fragment */);

}
public boolean validate(resourceID) {

String SecurityRequestData =

prompt(“Enter Security Request Data: ”);

if(SecurityRequestData != null) {

DatabaseInterface DBIF = new DatabaseInterface( );
DBIF.assert(SecurityRequestData, resourceID);
return true;

}
else return false;

}

} // SecurityControlClass

The pseudocode security control class depicts an object oriented ‘interface.’ In Java, such structures are literally known as ‘interfaces’ to be ‘extended’ by concrete classes. In C++, such structures are known as abstract base classes from which concrete subclasses inherit. Either way, the pseudocode security control class establishes a set of public member methods to be used by all security control objects. The pseudocode security control class provides string storage of security control data, which may work just fine for logon IDs and passwords, but will not work for fingerprints and voice recognition. Similarly, setSecurityContolData( ) and validate( ) will be implemented differently for different types of security control data.

The member fields and member methods of the pseudocode security control class form an interface that is fully expected to be overridden in subclasses from which security control objects are instantiated, although all subclasses are required to implement in some fashion the public member fields and public member methods of the abstract base class, the security control class. Here, beginning with a concrete security control class for logon IDs, are examples of concrete security control classes from which practical security control objects are instantiated by the factory method SecurityControlClass.createSCO( ).

//
// concrete security control class for logon IDs
//
Class LogonIDSecurityControlClass : SecurityControlClass {

private String SecurityControlData;
public void setSecurityControlData(resourceID) {

SecurityControlData =

prompt( “Please Enter Security Control Data: );

DatabaseInterface DBIF = new DatabaseInterface( );
DBIF.assert(SecurityControlData, resourceID);
return(String/* security rule fragment */ );

}
public boolean validate(resourceID) {

SecurityRequestData =

prompt(“Enter Security Request Data: ”);

if(SecurityControlData != null) {

DatabaseInterface DBIF = new DatabaseInterface( );
DBIF.assert(SecurityRequestData, resourceID);
return true;

else return false;

}

}

The LogonIDSecurityControlClass appears similar to its parent SecurityControlClass, but it is useful to remember that LogonIDSecurityControlClass, unlike its abstract parent, defines a class that can actually be instantiated as a security control object for determining access to resources on the basis of entry of a valid logon ID. The following pseudocode security control class for fingerprints illustrates how security control classes differ across security control data types.

//
// concrete security control class for fingerprints
//
Class FingerprintSecurityControlClass : SecurityControlClass {

private File SecurityControlData;
public void setSecurityControlData(resourceID) {

SecurityControlData =

prompt( “Please Enter Security Control Data: );

DatabaseInterface DBIF = new DatabaseInterface( );
DBIF.assert(SecurityControlData, SCDType);
return(String/* security rule fragment */ );

}
public boolean validate(resourceID) {

FILE SecurityRequestData =

prompt(“Enter Security Request Data: ”);

if((boolean BC = bitwiseCompare(SecurityControlData,

SecurityRequestData)) == true) {

DatabaseInterface DBIF = new DatabaseInterface( );
DBIF.assert(SecurityRequestData, resourceID);
return true;

}
else return false;

}

}

In FingerprintSecurityControlClass, SecurityControlData is in a file rather than a string. Similarly, the prompt( ) function in the validate( ) method expects the user to provide a fingerprint file in response to the prompt for security control data. In addition, the bitwiseCompare( ) method, although not shown, is implemented to open both files, compare them bit by bit, and ultimately deny access to a resource if the comparison fails.

The pseudocode abstract security control class and its concrete subclasses assert security control data and security request data as security facts in a security knowledge database by calls to DBIF.assert( ). “DBIF” is a reference to a class that implements an interface to a security knowledge database, instantiated in this example by “DatabaseInterface DBIF=new DatabaseInterface( );”. Such an interface to a security knowledge database can be implemented, for example, according to the following pseudocode database interface class:

//
// Database Interface Class
//
// Defines interface for logic programming and
// inference engine.
//
class DatabaseInterface {

public boolean assert(String SecurityControlData, SCDType = “”, ResourceID
aResource)
{
switch(SCDType) {

case LOGONID:

Prolog.assert(“userID(” + “SCD” + “,” + aResource + “,” +

SecurityControlData + “)”); break;

case PASSWORD:

Prolog.assert(“password(”+ “SCD” + “,” aResource + “,” +

SecurityControlData + “)”); break;

case FINGERPRINT:

Prolog.assert(“fingerprint(“+ “SCD” + “,” + aResource + “,” +

| | SecurityControlData + ”)”); break; |
|---|---|
| ... ... ... | // Can have many security control data types, |

// not merely these five . . .

case RETINA:

Prolog.assert(“retina(“+ “SCD” + “,” aResource + “,” +

SecurityControlData + “)”); break;

case GPS:

Prolog.assert(“gps(“+ “SCD” + “,” aResource + “,” +

SecurityControlData + “)”); break;

} // end switch( )

} // end assert( )
public boolean goal(String PredicateString, resourceID aResource) {

boolean Grant = Prolog.goal(PredicateString + “(“ + aResource +“)”);
if(Grant) return true;
else return false;
} // end goal( )
public boolean retract(resourceID aResource) {
Prolog.retract(/* all security request data for ‘aResource’ */);
} // end retract( )

} // class DatabaseInterface

This example database interface class provides member methods for asserting security control data, for querying the database, and for retracting security facts from the database. The assert( ) method operates by concatenating elements of a security fact clause for insertion into a security knowledge database. In the case of a userID, for example, the concatentation

“userID(”+“SCD”+“,”+aResource+“,”+SecurityControlData+“)”,

from the Prolog.assert( ) call for LOGONID, given a resource named ‘myFile’ and a logonID of ‘fred,’ constructs a security fact of the form:

userID(“SCD”, myFile, fred).

The method Prolog.assert( ) calls through an object oriented interface provided by a Prolog implementation itself, for direct calls to Prolog methods. Many implementations of Prolog provide such interfaces. Examples of Prolog implementations that support direct, object-oriented interfaces, including interfaces for Java and/or C++, readily available ‘off-the-shelf,’ as it were, include “Amzi! Prolog” from Amzi!, Inc.; “SICS Prolog” and “Quintus Prolog,” both from the Swedish Institute of Computer Science; “Jinni 2000” (Java INference Engine and Networked Interactor) from BinNet Corporation of Denton, Tex.; and “MINERVA” from IF Computer Japan Limited, Tokyo.

Similarly, DatabaseInterface.goal( ) formulates and submits Prolog queries by use of the direct Prolog call Prolog.goal( ), and DatabaseInterface.retract( ) provides means for submitting a direct Prolog call, through Prolog.retract( ), for retracting security facts and rules from a Prolog security knowledge database. DatabaseInterface.retract( ) is shown here as means for retracting security request data for a resource previously asserted as security facts in a security knowledge database. Clearly, however, methods such as DatabaseInterface.retract( ) can readily be modified, overloaded, or overridden to retract any security rules or security facts as may be advantageous in administration or utilization of security knowledge databases, including, for example, retracting security control data as needed.

As noted below in the detailed discussion of security objects themselves, when the exemplary database interface class is instantiated in support of assertions and retractions, it is referred to as a database interface or ‘DBIF,’ acknowledging its role as an interface to a security knowledge database. When the same example database interface class is instantiated in support of submission of queries, however, it is referred to as an ‘inference engine.’

Security objects can be implemented, for example, according to the following pseudocode security class.

//
// SecurityClass . . .
// a class from which security objects can be instantiated
//
Class SecurityClass
{

private Resource aResourceID;
public void setResourceID(resourceID) {

aResourceID = resourceID

}
char anAuthorizationLevel;
public void setAuthorizationLevel(authorizationLevel) {

anAuthorizationLevel = authorizationLevel

}
//list of security control objects (references, actually)
private List aList = new List( );
// method for adding Security Control Objects to the List
public void add(SCO) {

aList.add(SCO);

}
// assert security request data as
// security facts for all SCOs in the list
public boolean main( )
{

SCO = aList.getFirst( );
while(SCO != null)

{

// SCO.validate( ) asserts security request data
if((SCO.validate( )) != true) {

| | |
|---|---|
| denyAccess( ); | // validate( ) unable to retrieve or |
| return false; | // assert security request data |

}
SCO = aList.getNext( );

}
// all SCOs in the List have now asserted security request data,
// obtain reference to inference engine
DatabaseInterface InferenceEngine = new DatabaseInterface( );
// infer whether to grant access to the resource
boolean AccessGranted = false;
AccessGranted = InferenceEngine.goal(“grantAccess”, aResource);
// retract security request data from security facts
InferenceEngine.retract(“SRD”, resourceID);
if (AccessGranted) {

AccessScope(anAuthorizationLevel);
return true;

}
else return false;

} // end main( )
} // end SecurityClass

The security class provides a storage location for a resource identification (312) named ‘resource ID,’ as well a member method named setResourceID( ) for storing (302) the resource identification. Similarly, the security class provides a field for authorization level and a method for storing (304) authorization level. The exemplary pseudocode security class provides storage in the form of a list for storing security control objects. In C++, it would be possible to store security control objects as such, but in typical embodiments, the list is used to store security control objects as references.

The security class includes a method, addSCO( ) for adding a security control object to the list. The methods aList.add( ), aList.getFirst( ), and aList.getNext( ) are member methods in a list object that effectively operate a list object as an iterator. An ‘iterator’ is a conventional object oriented design pattern that supports sequential calls to elements of an aggregate object without exposing underlying representation. In this example, main( ) assumes that aList.getNext( ) returns null upon reaching the end of the list. It is common also, for example, for list classes to support a separate member method called, for example, ‘isDoneo,’ to indicate the end of a list. Any indication of the end of a list as will occur to those of skill in the art is well within the scope of the present invention.

In addition, the exemplary pseudocode security class includes a validation method, a member method, main( ), that validate( ) security request data for each security control object in the list. In this particular example, the validation method is called ‘main( )’ to support implementing security objects in Java, so that the validation method can be called by a call to the object name itself. On the other hand, when SecurityClass is implemented as a Java servlet, there is no requirement for a member method named ‘main( ),’ because, although servlets also are invoked by use of the class name itself, the interior interface requirements for servlets are different. When SecurityClass is implemented as a Java servlet, therefore, the name of the member method ‘main( )’ is changed to implement a member method signature from the standard Java servlet interface, such as, for example:

public void service(ServletRequest req, ServletResponse res).

The validation method main( ) operates by obtaining from the list each security control object in turn and calling in each security control object the interface member method ‘validate( ).’ As described in detail above, the validate( ) method in each security control object prompts for and retrieves from a user securityrequest data, asserts the security request data as security facts in the security knowledge database, and returns true or false according to whether SCO.validate( ) successfully retrieves and asserts the security request data. SecurityClass.main( ) operates by denying access and returning false if an assertion in support of validation fails for any security control object in the list. SecurityClass.main( ) proceeds with processing if SCO.validate( ) succeeds for all security control objects in the list.

SecurityClass.main( ) proceeds by obtaining a reference to the inference engine by:

DatabaseInterface InferenceEngine=new DatabaseInterface( );

InferenceEngine is a reference to the same example database interface class used above in support of assertions and retractions, when it was referred to as a database interface or ‘DBIF.’ When the same example database interface class is instantiated here in support of submission of queries to a knowledge base, it is referred to as an ‘inference engine,’ using the reference name ‘InferenceEngine.’

SecurityClass.main( ) queries whether access is to be granted to the resource by:

AccessGranted=InferenceEngine.goal(“grantAccess”, aResource);

If access is granted, SecurityClass.main( ) sets the authorization level by:

AccessScope(anAuthorizationLevel);

and returns true. If access is denied, SecurityClass.main( ) returns false. Regardless whether access is granted or denied, in order to reduce the likelihood of ambiguous queries to the security knowledge database occasioned by multiple sets of security request data, SecurityClass.main( ) retracts the security request data asserted through the calls to SCO.validate( ) by:

InferenceEngine.retract(“SRD”, resourceID).

If SecurityClass.main( ) grants access, the access granted has the authorization level set by the member method setAuthorizationLevel( ). More particularly, in the method of FIG. 2, determining (220) access (222) includes authorizing a level of access in dependence upon the authorization level of access for the resource (314 on FIG. 3). In the example of security objects implemented to accept calls from hyperlinks in web pages displayed in browsers on client devices located remotely across a network, the security objects themselves often are implemented as servlets or CGI programs that administer HTTP GET and PUT request messages. In such exemplary embodiments, a security object granting access to a resource having only ‘read’ authorization level would honor a GET request by transmitting to the client browser a copy of the resource in HTML. The same exemplary security object, however, would not honor a PUT request for writing data to the resource.

FIG. 4 sets forth a class relations diagram summarizing exemplary relations among classes and objects useful in various embodiments of the present invention. As shown in FIG. 4, in many embodiments, concretes security classes (108), from which security objects are instantiated, are subclasses that inherit from abstract security classes (402). Similarly, concrete security control classes (316), from which security control objects are instantiated, are subclasses that inherit from abstract security control classes (404).

In addition, it is useful to remember that ‘abstract,’ as the term is used here to describe classes, is used in support of interface definition, in a fashion similar to its use in the terminology of C++. In Java, structures that here are called abstract classes would be called ‘interfaces,’ as such. No doubt such structures have other names in other environments, but here they are called ‘abstract classes’ and used to illustrate declarations of object oriented interfaces.

Foundries (224) are shown in FIG. 4 as classes having references to factory classes (406) and concrete security classes (108). Foundries (224), as described in detail above, cooperate with factories (406) and security objects instantiated from concrete security classes (316) by passing to security objects references to security control objects for inclusion in security control object lists (318). The arrow (412) can be drawn between security classes (108) and security control classes (316), indicating that a security class ‘has a’ security control class, because the reference needed to implement the object oriented ‘has a’ relationship is provided to the security class by a foundry (224) for storage in a security control object list (318).

As shown in FIG. 4, foundries (224), concrete security control classes (315), and concrete security classes (107) all have references to security knowledge database interfaces (414). Foundries (224) call security knowledge database interface objects (414) to assert security rules. Concrete security control classes (315) call security knowledge database interface objects (414) to assert security facts. Concrete security classes (107) call security knowledge database interfaces (414), as inference engines, to submit queries and to retract certain security facts, that is, security facts comprising security request data.

Security control object lists (318) are often implemented as container objects from a standard library in, for example, C++ or Java. That is, a security control object list (318) is typically a class object aggregated by reference to a security object (108) instantiated from a security class (107). With member methods (410) such as add( ), getFirst( ), and getNext( ), a security control object list (318) often can function as a so called ‘iterator,’ greatly easing manipulation of security control objects on behalf of a security object. Iterator operations are illustrated in the pseudocode above for SecurityClass.

Again referring to FIG. 2, the illustrated method includes deploying (226) a security object. Security objects can be created (206) on a client device and deployed (226) to a client device (102), including the same client device on which the security object is created, or to a server (106). Security objects can be created (206) on a server and deployed (226) to a server (106), including the same server on which the security object is created, or to a client device (102). Deployment can be local, that is, within the same client device or server, or within a trusted LAN.

Deployment can be remote, that is, across public networks, such as, for example, the Internet or the World Wide Web. One advantageous mode of remote deployment, for example, is a download of a security object implemented as a Java applet to a Java-enabled web browser. An applet is a Java program designed to be run from another program, such as a browser, rather than directly from an operating system. Because applets typically are small in file size, cross-platform compatible, and highly secure (can't be used to access users' hard drives), they are useful for small Internet applications accessible from a browser, including, for example, security objects according to the present invention.

More particularly, in some embodiments according to the method of FIG. 2, a resource (112) resides on a resource server (110), and the method includes deploying (226) the security object (108) on a security server (106) and receiving (208) the request for access to the resource in a security server (106) from a client device (102) across a network (202). Network (202), as mentioned above, can be any network, public or private, local area or wide area, wireless or wired. In embodiments according to this aspect of the invention, receiving (208) a request for access (210) is typically carried out through some form of remote procedure call, such as, for example, a hyperlink to a Java servlet, a hyperlink to a CGI function, a call to a member method in a CORBA object, a remote object call through a Java RMI interface, or a remote object call through a DCOM interface.

In a further aspect of the method of FIG. 2, a resource (112) resides on a client device (102), and the client device has an application program (120 on FIG. 1c) that accesses the resource. In this kind of embodiment, the method includes deploying (226) the security object (108) on the client device (102), effecting an architecture like the one shown in FIG. 1c. In this configuration, receiving (208) a request (210) for access to the resource (112) includes receiving (208) the request for access to the resource in the security object itself as a call to the security method (218). In some embodiments of this kind, in fact, a security object (108) can be compiled right into the client application (120), so that receiving a request for access is implemented as a conventional local function call, with no particular need for remote procedure calling methodologies such as those listed above—hyperlinks, CORBA, Java RMI, and so on.

In some embodiments of the present invention receiving (208) a request for access (210) to a resource (112) comprises a call to a security method (218) in a security object (108). Such direct calls can be implemented through Java, for example, by naming the security method (218) ‘main( )’ and issuing a call of the form java SecurityObjectName.’ Alternatively, a call may be issued from a hyperlink in a browser to a security method in a security object implemented as a Java servlet by including in an HTTP request message a URI of the form:

http://ServerName/servlet/MySecurityObject

where MySecurityObject is the name of a security object implemented as a servlet and containing a security method named according to the conventions of the standard Java servlet interface, that is, for example, named ‘service( ).’

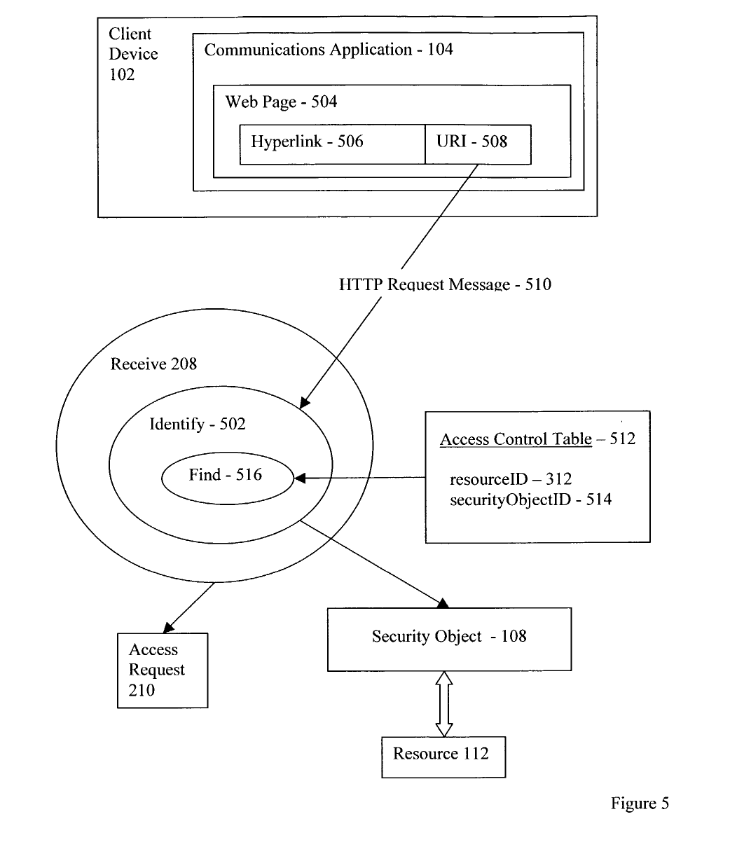

FIG. 5 sets forth a data flow diagram illustrating more detailed embodiments of receiving (208) a request (210) for access to a resource. In one method according to FIG. 5, receiving (208) a request (210) for access to a resource (112) includes identifying (502) a security object (108), that is, identifying a security object that controls access to the resource. Consider the example mentioned earlier of a security object (108) implemented as a Java servlet. In such an exemplary embodiment, identifying (502) the security object (108) comprises identifying the security object in dependence upon a URI (508). Typically, the URI (508) originates from a hyperlink (506) in a web page (504) in a communications application (104) in a client device (102). The communications application can be, for example, a browser in a client device that is a personal computer or a microbrowser in a client device that is a web-enabled cell phone. Such embodiments typically communicate the identification of the security object in the form of an HTTP request message containing the URI. The URI can have this form:

http://ServerName/servlet/MySecurityObject

from which a servlet-enabled server can invoke the security object as a servlet named MySecurityObject. The server does not invoke the security object in the sense of calling it as such. The server ‘invokes’ the security object in that the server calls a member method within the security object according to the conventions of the standard Java servlet interface. In this example, the identity of the security object was known to the calling application.

It is possible, however, that the calling application may know the identity of a resource without knowing the identity of the security object that controls access to the resource. In such an exemplary embodiment, a request for access to a secured resource may arrive in an HTTP request directed at a resource that is a document identified as:

http://ServerName/SomeoneElse'sFiles/Document123.

For use in such embodiments, in one method according to FIG. 5, identifying (502) the security object (108) includes identifying the security object in dependence upon a URI (508) that identifies the resource (112), including finding (516), in dependence upon the URI (508) identifying the resource (112), an identification (514) of the security object in an access control table (512).

Although in this example, where the access request came with a URI, the identification (312) of the resource is, for example, a URI or a filename or pathname extracted from a URI. In embodiments of the invention generally, there is no requirement that the communications application be a browser or use HTTP for its communications. The resource identification (312) can be any digital identification, including for example, a filename or pathname communicated in a plaintext string or in cyphertext.

The identification (514) of the security object can be the security object name, for example, or, in the example where the security object is implemented as a Java servlet, the identification (514) of the security object can be a URI in the now familiar form:

http://ServerName/servlet/MySecurityObject.

In this kind of embodiment, a security server is programmed upon receiving a request for access, to check an access control table (512). In fact, this small change in the overall programming of the security server, is the only thing that makes it a ‘security server’ within the meaning of the present invention. The security server needs no other security-related service upon it. Security authentication and authorization are handled by the security object. All the security server needs to do is look up the identity of the security object and invoke it. ‘Invoke’ in this sense means to call the security method in the security object by, for example, a call to java ‘SecurityObjectName’ for a security object implemented as a standard Java class, a call to ‘http://ServerName/servlet/MySecurityObject’ for a security object implemented as a Java servlet, or a call to ‘SecurityObjectName’ for a security object implemented as a C++ program. If the security server can find no security object for the resource identified in a request for access, then the security server continues its normal operations. If the security server is programmed to grant access only upon finding a corresponding security object, then the security server denies access when no such object is found in the access control table. If the security server has other security services available upon it, then it is often programmed to apply them in its usual fashion.

Alternatively, if the security server has no other security services available upon it, it may be programmed to comply with HTTP request messages on their own terms according to whether they are GET messages, PUT messages, and so on. In other words, the security server can implement the standard operations of a web server. This implementation is a little riskier than the other two examples mentioned just above but it has the advantage of being very easy to implement, requiring as it does only one small change to the source code of a conventional web server just to do one lookup in an access control table and, if the lookup succeeds, invoke a security object identified in the lookup.

By this point in this disclosure, several advantages of using various embodiments of the present invention are clear. One advantage is pure flexibility, especially at the user level and the application level. Embodiments of the present invention can make foundry applications available to ordinary users, rather then just to system administrators. Any user can choose to associate with any resource any kind of security data supported in a security system. Users can decide for themselves whether they want just a plain text logon ID and/or something much more elaborate—a fingerprint, a voiceprint, a retinal scan, and so on. As a result, users can be given great freedom in defining the security content and security level for securing users' resources, much greater freedom than available to users in prior art systems.

Another advantage of security objects according to the present invention is that security servers, communications servers, resource servers such as document or application servers—none of the servers in networks need to have any particular concern with security beyond associating a security object with a resource. Moreover, as mentioned above, it is possible within the present invention to establish a regime in which all resources in a particular location are accessed only indirectly through security objects, in which case, a server providing access to such resources need have upon it no other security service whatsoever, at least as regards authentication and authority level. In particular, servers that administer access to resources need not be concerned with the type of security data provided by users or required to qualify for access to a resource.

Another advantage of the present invention relates to encryption. As described above, certain elements of security control data are advantageously stored in encrypted form. Persons seeking unauthorized access to resources may seek to decrypt such security control data. Such unauthorized access is made much more difficult by a need, easily established by any properly authorized user, to decrypt not only a single security control data element such as a password, but also to decrypt multiple security control data elements including fingerprints, retinal scans, voiceprints, and so on.

Another advantage of the present invention is the ease with which a user can arrange multiple access authorization for multiple users. A user authorized to do so, under the present invention, can simply create multiple security objects for a single resource and distribute, for example, a URI identifying each such separate security object to separate users. By such usage, a user can quickly grant with respect to a particular document, for example, ‘read’ access to Jane Smith, ‘read’ access to Joe Blow, ‘write’ access to Mike Walker, and reserve ‘execute’ access to the original user, the owner of the document. The security control data can be set differently in each of the separate security objects all of which point to the same document, therefore preventing Jane and Joe from using Mike's security object to gain access, even if they can gain access to Mike's security object.

Another advantage is reduction of security responsibility on the part of server system administrators. This advantage obtains because security objects of the present invention tend to upcast security control from communications protocols layers to application layers. “Layers” in this context refers to the standard data communications protocol stack in which the IP protocol resides in layer 3, the so called ‘network layer,’ and the Transmission Control Protocol, or “tcp,” resides in layer 4, the so called transport layer. In this context, SSL is considered a layer 4 security protocol, and the well known protocol for virtual private networking known as “IPSec” is considered a layer 3 protocol. In this disclosure, any functionality above layer 4 is described as residing in an ‘application layer.’ Therefore security objects according to the present invention are considered to be application layer software. As such, security objects and their operations in securing access to resources are completely transparent to systems administrators working on layer 4 or layer 3 security systems. In fact, it is possible to structure web servers as security servers, as mentioned above, so that such security servers have little or no concern regarding whether layer 4 or layer 3 security systems even exist at all. This is potentially a dramatic shift in security responsibilities for system administrators, including, for example, system administrators in Internet Service Providers or ‘ISPs.’

It will be understood from the foregoing description that various modifications and changes may be made, and in fact will be made, in the exemplary embodiments of the present invention without departing from its true spirit. The descriptions in this specification are for purposes of illustration only and are not to be construed in a limiting sense. The scope of the present invention is limited only by the language of the following claims.

What is claimed is:

1. A method of controlling access to a resource, the method comprising:
creating a security object in dependence upon user-selected security control data types, including asserting security control data as security facts into a security knowledge database and asserting security rules into the security knowledge database, the security object comprising security control data and at least one security method;
receiving a request for access to the resource;
receiving security request data;
asserting the security request data as security facts into the security knowledge database; and
determining access to the resource in dependence upon the security facts and security rules in the security knowledge database.

2. The method of claim 1 further comprising removing from the security knowledge database at least some of the security request data asserted as security facts.

3. The method of claim 1 wherein creating a security object further comprises:
storing in the security object a resource identification for the resource;
storing in the security object an authorization level of access for the resource;
storing in the security object user-selected security control data types; and
storing, in the security object, security control data for each user-selected security control data type.

4. The method of claim 1 wherein determining access includes authorizing a level of access in dependence upon the authorization level of access for the resource.

5. The method of claim 1 wherein determining access to the resource further comprises inferring whether access is granted, the inferring carried out in dependence upon the security facts and security rules in the security knowledge database.

6. The method of claim 1 wherein determining access to the resource further comprises inferring with an inference engine whether access is granted, the inferring carried out in dependence upon the security facts and security rules in the security knowledge database.

7. The method of claim 1 further comprising deploying the security object.

8. The method of claim 1 wherein receiving a request for access to the resource comprises calling the security method.

9. The method of claim 1 wherein receiving a request for access to the resource further comprises identifying the security object.

10. The method of claim 9 wherein identifying the security object comprises identifying the security object in dependence upon a URI.

11. The method of claim 9 wherein identifying the security object comprises identifying the security object in dependence upon a URI that identifies the resource, including finding, in dependence upon the URI identifying the resource, an identification of the security object in an access control table.

12. A system for controlling access to a resource, the system comprising:
means for creating a security object in dependence upon user-selected security control data types, including means for asserting security control data as security facts into a security knowledge database and asserting security rules into the security knowledge database, the security object comprising security control data and at least one security method;
means for receiving a request for access to the resource;
means for receiving security request data;
means for asserting the security request data as security facts into the security knowledge database; and
means for determining access to the resource in dependence upon the security facts and security rules in the security knowledge database.

13. The system of claim 12 further comprising means for removing from the security knowledge database at least some of the security request data asserted as security facts.

14. The system of claim 12 wherein means for creating a security object further comprises:
means for storing in the security object a resource identification for the resource;
means for storing in the security object an authorization level of access for the resource;
means for storing in the security object user-selected security control data types; and
means for storing, in the security object, security control data for each user-selected security control data type.

15. The system of claim 12 wherein means for determining access includes means for authorizing a level of access in dependence upon the authorization level of access for the resource.

16. The system of claim 12 wherein means for determining access to the resource further comprises means for inferring whether access is granted, the means for inferring operating in dependence upon the security facts and security rules in the security knowledge database.

17. The system of claim 12 wherein means for determining access to the resource further comprises means for inferring with an inference engine whether access is granted, the means for inferring operating in dependence upon the security facts and security rules in the security knowledge database.

18. The system of claim 12 further comprising means for deploying the security object.

19. The system of claim 12 wherein means for receiving a request for access to the resource comprises means for calling the security method.

20. The system of claim 12 wherein means for receiving a request for access to the resource further comprises means for identifying the security object.

21. The system of claim 20 wherein means for identifying the security object comprises means for identifying the security object in dependence upon a URI.

22. The system of claim 20 wherein means for identifying the security object comprises means for identifying the security object in dependence upon a URI that identifies the resource, including means for finding, in dependence upon the URI identifying the resource, an identification of the security object in an access control table.

23. A computer program product for controlling access to a resource, the computer program product comprising:
a recording medium;
means, recorded on the recording medium, for creating a security object in dependence upon user-selected security control data types, including means, recorded on the recording medium, for asserting security control data as security facts into a security knowledge database and asserting security rules into the security knowledge database, the security object comprising security control data and at least one security method;
means, recorded on the recording medium, for receiving a request for access to the resource;
means, recorded on the recording medium, for receiving security request data;
means, recorded on the recording medium, for asserting the security request data as security facts into the security knowledge database; and
means, recorded on the recording medium, for determining access to the resource in dependence upon the security facts and security rules in the security knowledge database.

24. The computer program product of claim 23 further comprising means, recorded on the recording medium, for removing from the security knowledge database at least some of the security request data asserted as security facts.

25. The computer program product of claim 23 wherein means, recorded on the recording medium, for creating a security object further comprises:
means, recorded on the recording medium, for storing in the security object a resource identification for the resource;
means, recorded on the recording medium, for storing in the security object an authorization level of access for the resource;
means, recorded on the recording medium, for storing in the security object user-selected security control data types; and
means, recorded on the recording medium, for storing, in the security object, security control data for each user-selected security control data type.

26. The computer program product of claim 23 wherein means, recorded on the recording medium, for determining access includes means, recorded on the recording medium, for authorizing a level of access in dependence upon the authorization level of access for the resource.

27. The computer program product of claim 23 wherein means, recorded on the recording medium, for determining access to the resource further comprises means, recorded on the recording medium, for inferring whether access is granted, the inferring carried out in dependence upon the security facts and security rules in the security knowledge database.

28. The computer program product of claim 23 wherein means, recorded on the recording medium, for determining access to the resource further comprises means, recorded on the recording medium, for inferring with an inference engine whether access is granted, the inferring carried out in dependence upon the security facts and security rules in the security knowledge database.

29. The computer program product of claim 23 further comprising means, recorded on the recording medium, for deploying the security object.

30. The computer program product of claim 23 wherein means, recorded on the recording medium, for receiving a request for access to the resource comprises means, recorded on the recording medium, for calling the security method.

31. The computer program product of claim 23 wherein means, recorded on the recording medium, for receiving a request for access to the resource further comprises means, recorded on the recording medium, for identifying the security object.

32. The computer program product of claim 31 wherein means, recorded on the recording medium, for identifying the security object comprises means, recorded on the recording medium, for identifying the security object in dependence upon a URI.

33. The computer program product of claim 31 wherein means, recorded on the recording medium, for identifying the security object comprises means, recorded on the recording medium, for identifying the security object in dependence upon a URI that identifies the resource, including means, recorded on the recording medium, for finding, in dependence upon the URI identifying the resource, an identification of the security object in an access control table.
